(19) United States
(12) Patent Application Publication
(10) Pub. No.: US 2018/0294965 A1
(43) Pub. Date: Oct. 11, 2018

(54) APPARATUS, METHOD AND COMPUTER PROGRAM PRODUCT FOR AUTHENTICATION

(71) Applicant: Nokia Technologies Oy, Espoo (FI)

(72) Inventor: Zheng YAN, Shaanxi (CN)

(21) Appl. No.: 15/766,994

(22) PCT Filed: Oct. 15, 2015
(86) PCT No.: PCT/CN2015/091972

§ 371 Date: Apr. 9, 2018

(51) Int. Cl. H04L 9/32; H04L 9/00; G06K 9/00; G10L 17/00

(52) U.S. Cl. CPC H04L 9/3231; H04L 9/008; G10L 17/005; H04L 9/006; G06K 9/00422; H04L 9/321

(57) ABSTRACT

Methods, apparatus, computer program product and computer readable medium are disclosed for authentication. A method comprises: receiving an authentication request from a user apparatus (802); sending a verification code to the user apparatus, wherein the verification code comprises a combination of pattern codes and the pattern codes are associated with encrypted bio-patterns that the user has registered respectively (804); receiving first encrypted bio-information of the user corresponding to the verification code (806); and calculating a first encrypted deviation between the registered encrypted bio-patterns corresponding to the combination of pattern codes and the codes and the pattern codes are associated with encrypted first encrypted bio-information (808).

### FIELD OF THE INVENTION

Embodiments of the disclosure generally relate to data processing, and more particularly, to technologies for authentication.

### BACKGROUND

Security is becoming more and more important with the fast growth of online and cloud services, as well as various electronic devices such as portable and wearable devices. Usability and privacy protection are important issues for the acceptance of a user authentication mechanism.

Nowadays, a very common way for user authentication may be based on the match of a user ID and/or its password (e.g., a graphic or literal password) with the registered ones. Many services and/or devices apply this method. It is very common that a user may hold several IDs and passwords. However, remembering all those IDs and passwords may become more and more difficult for the user especially when a service requests to set up a high-secure password, or the user may not have a good memory, or the user hasn't access some services for a long time. Moreover, an attacker may intrude such an authentication system and steal a large number of IDs and passwords. This may lead to a great loss to the user especially when the user sets the same ID and password for multiple services and devices. In addition, bio-information (e.g., voice, palm-print, fingerprint etc.) may be also applied for user authentication. There is no need for the user to remember his/her IDs and passwords. But one drawback of this authentication method is that the bio-information may be disclosed to a third distrusted party and some bio-information may be faked by the attacker. Thus, an improved authentication solution is desirable.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one aspect of the disclosure, it is provided a method for authentication. Said method may comprise: receiving an authentication request from a user apparatus; sending a verification code to the user apparatus, wherein the verification code comprises a combination of pattern codes and the pattern codes are associated with encrypted bio-patterns that the user has registered respectively; receiving first encrypted bio-information of the user corresponding to the verification code; and calculating a first encrypted deviation between the registered encrypted bio-patterns corresponding to the combination of pattern codes and the first encrypted bio-information.

According to another aspect of the present disclosure, it is provided an apparatus comprising means configured to carry out the above-described method.

According to another aspect of the present disclosure, it is provided a computer program product embodied on a distribution medium readable by a computer and comprising program instructions which, when loaded into a computer, execute the above-described method.

According to another aspect of the present disclosure, it is provided a non-transitory computer readable medium having encoded thereon statements and instructions to cause a processor to execute the above-described method.

According to another aspect of the present disclosure, it is provided an apparatus for authentication. Said apparatus may comprise a receiving element configured to receive an authentication request from a user apparatus; a sending element configured to send a verification code to the user apparatus, wherein the verification code comprises a combination of pattern codes and the pattern codes are associated with encrypted bio-patterns that the user has registered respectively; the receiving element further configured to receiving first encrypted bio-information of the user corresponding to the verification code; and a calculating element configured to calculate a first encrypted deviation between the registered encrypted bio-patterns corresponding to the combination of pattern codes and the first encrypted bio-information.

According to one aspect of the disclosure, it is provided a method for authentication. Said method may comprise: receiving an encrypted-deviation from an identity provider; operating on the encrypted-deviation; and determining authentication result based on the operation result.

According to another aspect of the present disclosure, it is provided an apparatus comprising means configured to carry out the above-described method.

According to another aspect of the present disclosure, it is provided a computer program product embodied on a distribution medium readable by a computer and comprising program instructions which, when loaded into a computer, execute the above-described method.

According to another aspect of the present disclosure, it is provided a non-transitory computer readable medium having encoded thereon statements and instructions to cause a processor to execute the above-described method.

According to another aspect of the present disclosure, it is provided an apparatus for authentication. Said apparatus may comprise a receiving element configured to receive an encrypted-deviation from an identity provider; an operating element configured to operate on the encrypted-deviation; and a determining element configured to determine authentication result based on the operation result.

According to one aspect of the disclosure, it is provided a method for authentication. Said method may comprise: sending an authentication request to an identity provider; receiving a verification code from the identity provider, wherein the verification code comprises a combination of pattern codes and the pattern codes are associated with encrypted bio-patterns that the user has registered respectively; and sending first encrypted bio-information of the user corresponding to the verification code to the identity provider.

According to another aspect of the present disclosure, it is provided an apparatus comprising means configured to carry out the above-described method.

According to another aspect of the present disclosure, it is provided a computer program product embodied on a distribution medium readable by a computer and comprising program instructions which, when loaded into a computer, execute the above-described method.

According to another aspect of the present disclosure, it is provided a non-transitory computer readable medium having encoded thereon statements and instructions to cause a processor to execute the above-described method.

According to another aspect of the present disclosure, it is provided an apparatus for authentication. Said apparatus may comprise a sending element configured to send an authentication request to an identity provider; a receiving element configured to receive a verification code from the identity provider, wherein the verification code comprises a combination of pattern codes and the pattern codes are associated with encrypted bio-patterns that the user has registered respectively; and the sending element further configured to send first encrypted bio-information of the user corresponding to the verification code to the identity provider.

These and other objects, features and advantages of the disclosure will become apparent from the following detailed description of illustrative embodiments thereof, which is to be read in connection with the accompanying drawings.

### BRIEF DESCRIPTION OF THE DRAWINGS

FIG. 1 shows a schematic system, in which some embodiments of the present disclosure can be implemented;

FIG. 2 is a simplified block diagram illustrating an apparatus according to an embodiment of the present disclosure;

FIG. 3 is a simplified block diagram illustrating an apparatus according to another embodiment of the present disclosure;

FIG. 4 is a simplified block diagram illustrating an apparatus according to another embodiment of the present disclosure;

FIG. 5 is a simplified block diagram illustrating an apparatus according to another embodiment of the present disclosure;

FIG. 6 is a simplified block diagram illustrating an apparatus according to another embodiment of the present disclosure;

FIG. 7 is a flow chart depicting a process for authentication according to an embodiment of the present disclosure;

FIG. 8 is a flow chart depicting a process for authentication according to another embodiment of the present disclosure;

FIG. 9 is a flow chart depicting a process for authentication according to another embodiment of the present disclosure;

FIG. 10 is a flow chart depicting a process for authentication according to another embodiment of the present disclosure; and

FIG. 11 is a flow chart depicting a process for authentication according to another embodiment of the present disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

As used herein, homomorphic encryption is a form of encryption that allows computations to be carried out on ciphertext, thus generating an encrypted result which, when decrypted, matches the result of operations performed on the plaintext. A cryptosystem that supports arbitrary computation on ciphertexts is known as fully homomorphic encryption (FHE). Such a scheme enables the construction of programs for any desirable functionality, which can be run on encrypted inputs to produce an encryption of the result. Since such a program need never decrypt its inputs, it can be run by a distrusted party without revealing its inputs and internal state.

With the increasing popularity and fast growth of online and cloud services, as well as various electronic devices such as portable and wearable devices, users rely on the electric devices more and more to access the online and cloud services and other devices, such as a device in a smart home system. In general, most authentication systems used by the services may rely on an identity management (IdM) system or other suitable systems to facilitate the management of identifiers, credentials, personal information, and the presentation of this information to other parties.

For example, in the IdM system, all involved system entities may fall into three types of roles: a user apparatus (UA), who is trying to access a service or a device; a relying party (RP) that is the owner of the service or the device being accessed; an identity provider (IdP) that possesses the information on the UA and will provide the necessary information for authenticating the user to the RP. In many IdM systems, the IdP may issue identities or credentials to users, while the RP may depend on the IdP to check the user credentials before it allows the users access to the service or the device.

However, in the existing IdM systems or other authentication systems, as mentioned above, a user may need to hold several IDs and passwords. However, remembering all those IDs and passwords may become more and more difficult for the user. Moreover, the attacker may intrude such a system and steal a large number of IDs and passwords, thereby leading to a great loss to the user. In addition, though the bio-information may be used for user authentication, but some bio-information such as a fingerprint may be faked by the attacker. In addition, the bio-information may be disclosed to a third distrusted party. Therefore, it may be very desirable if the authentication solution can be easy-to-use, secure and capable of privacy preservation.

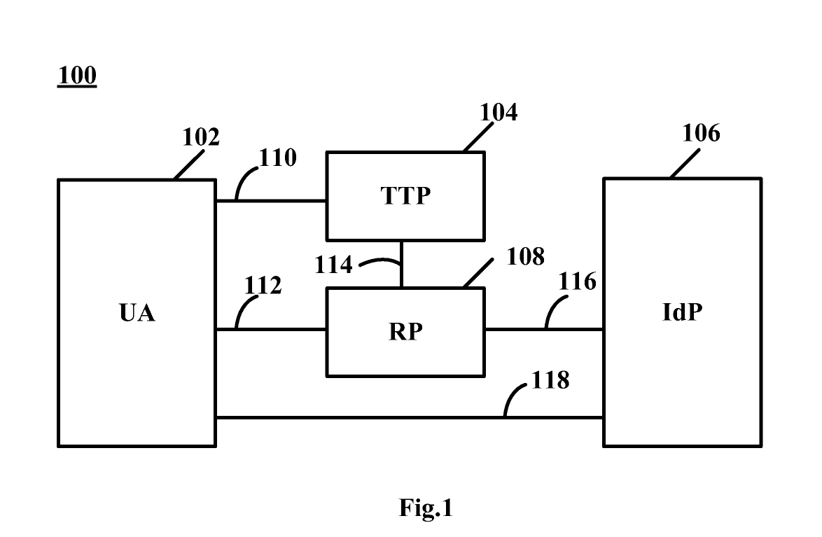

FIG. 1 depicts a schematic system, in which some embodiments of the present disclosure can be implemented. As shown in FIG. 1, the system 100 may comprise a user apparatus (UA) 102 operably connected to a relying party (RP) 108 through a link 112, connected to a trusted third party (TTP) 104 through a link 110, and connected to an identity provider (IdP) 106 through a link 118. The UA 102 can be implemented in form of hardware, software or their combination, including but not limited to, fixed terminal, mobile terminal, portable terminal, smart phone, desktop computer, cloud client, laptop computer, handset, station, unit, device, multimedia tablet, Internet/network node, communicator, Personal Digital Assistant (PDA), client software, or any combination thereof. The UA 102 may be used by a user to access the services provided by the RP 108 if the user has been authenticated by the RP 108. For example, the user of the UA 102 can access the services by using any suitable applications installed in the UA 102. In general, the UA 102 can be equipped with one or more I/O devices, such as microphone, camera, handwriting board, touch screen, display etc., to input and/or output the user's bio-information or other information. Noted that the system 100 can include one or more UAs 102 though only one UA 102 is shown in FIG. 1.

The system 100 may comprise the RP 108. The RP 108 may operably connect to the TTP 104 through a link 114, and connect to the IdP 106 through a link 116. The RP 108 can be implemented in form of hardware, software or their combination, including but not limited to, fixed terminal, mobile terminal, portable terminal, smart phone, server, desktop computer, laptop computer, cloud computer, handset, station, unit, device, multimedia tablet, Internet/network node, communicator, Personal Digital Assistant (PDA), service software, or any combination thereof. The RP 108 may maintain a pair of its public and private key and send its public key to the TTP 104, UA 102 and IdP 106. The RP 108 may provide at least one service that can be accessed by the UA 102. For example, the services can be any kind of services including, but not limited to, social networking service such as LinkedIn, Facebook, Twitter, YouTube, messaging service such as WeChat, Yahoo! Mail, device management service and on-line shopping service such as Amazon, Alibaba, TaoBao etc. The RP 108 may register its service at the IdP 106 as RP_id. In addition, the RP 108 may conclude the authentication with the support of the IdP 106. Noted that the system 100 can include one or more RPs 108 though only one RP 108 is shown in FIG. 1.

The system 100 may further comprise the TTP 104. The TTP 104 can be implemented in form of hardware, software or their combination, including but not limited to, fixed terminal, mobile terminal, portable terminal, smart phone, server, desktop computer, laptop computer, cloud computer, handset, station, unit, device, multimedia tablet, Internet/network node, communicator, Personal Digital Assistant (PDA), software, or any combination thereof. The TTP 104 may maintain a pair of its homomorphic public and private key and send its homomorphic public key to the RP 108 and UA 102. In an embodiment, the TTP 104 can generate a re-encryption key for the RP 108 and send it to the RP 108 such that the RP 108 is able to re-encrypt ciphertext encrypted by the homomorphic public key and then decrypt the re-encrypted ciphertext with the RP 108's private key. In another embodiment, the TTP 104 can assist the RP 108 to decrypt the ciphertext and send the decryption result to the RP 108.

The system 100 may further comprise the IdP 106. The IdP 106 can be implemented in form of hardware, software or their combination, including but not limited to, server, desktop computer, laptop computer, cloud computer, Internet/network node, communicator, service software, or any combination thereof. In addition, the IdP 106 can manage and store information related to the UA 102 and RP 108, possess the encrypted bio-information which is encrypted with the homomorphic public key of the TTP 104 by the UA 102, provide the necessary information for supporting the RP 108 to authenticate the user, and perform registration function, full homomorphic encryption function and/or other suitable functions.

As shown in FIG. 1, the links 110, 112, 114, 116 and 118 may be secure channels. For example, the security channels may be established between each two parties in the system 100 by applying a secure communication protocol, e.g., SSL or other suitable secure protocols, such as HTTPs. Moreover, both the IdP 106 and the RP 108 may be deployed as a cloud service.

In the system 100, it is required that the RP 108 and the IdP 106 cannot intrude user privacy. The RP 108 may authenticate the user with the support of the IdP 106. The TTP 104 may be responsible for key management (such as its homomorphic public and private key) and the re-encryption key issuing to the RP 108. In another embodiment, the TTP 104 may help the RP 108 to decrypt ciphertext encrypted by the TTP 104's public key.

In system setup, the TTP 104 may generate its homomophic public and private key pair (PK_TTP, SK_TTP). The RP 108 may generate its own public and private keys. The RP 108 may register its service at the IdP 106 as RP_id and get the TTP 104's public key PK TTP. In an embodiment, the RP 108 may request its re-encryption key (RK(ttp->rp)) from the TTP 104 such that the RP 108 can re-encrypt a ciphertext with the re-encryption key and decrypt the re-encrypted ciphertext with its private key, wherein the ciphertext is encrypted with the TTP 104's homomophic public key. Noted that any suitable existing and future re-encryption technologies can be used in the system 100, which allows the RP 108 to transform a ciphertext computed under the TTP 104's homomophic public key into one that can be opened by the RP 108's private key. In another embodiment, the RP 108 can send the ciphertext to the TTP 104 and indicate the TTP 104 to decrypt the ciphertext and send back the decryption result.

While the following embodiments are primarily discussed in the context of voice bio-information authentication, it will be understood by those of ordinary skill that the disclosure is not so limited. In fact, the various aspects of this disclosure are useful in any suitable bio-information authentication. For example, the user's bio-information can include the user's voice or handwriting. In addition, the user's bio-information may further comprise context information of the user. For example, the bio-information can be a combination of voice and other suitable information, such as other bio-information (e.g., handwiting, fingerprint, face, iris, etc.) and information around and/or related to the user (for example, background noise, surrounding temperature, login time, login device, etc.).

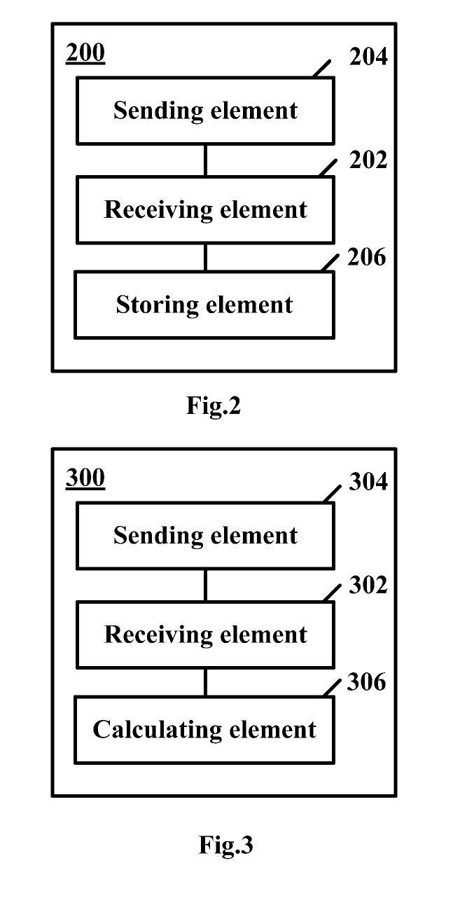

FIG. 2-3 separately show simplified block diagrams of an apparatus 200 and 300 for authentication in a system according to various embodiment of the present disclosure. As described above, the system may comprise the components as described in FIG. 1. The apparatus 200 and 300 can be implemented as a part of the IdP 106 in FIG. 1.

With reference to FIG. 2 and FIG. 1, the apparatus 200 may include a receiving element 202 configured to receive a registration request from the UA 102. For example, the receiving element 202 can directly receive the registration request from the UA 102. Alternatively, the receiving element 202 may receive the registration request forwarded by the RP 108. For example, the UA 102 can send the registration request to the RP 108 and then the RP 108 can forward the registration request to the apparatus 200. The registration request can contain any suitable information. For example, the registration request can contain the UA 102's address (UA_add), such as a MAC (media access control) address, an IPv4 or IPv6 address or other suitable UA's address. Noted that the UA 102 may contain multiple addresses, for example each address may correspond to a different user. In an embodiment, the registration request may not contain the UA 102's address and the receiving element 202 can obtain the UA 102's address from the packet head of the registration request. In another embodiment, the registration request may contain the RP_id. For example, if there are multiple services provided by the RP 108, then the registration request should contain the RP_id to indicate which service the user want to access. In this case, if the UA 102 has known the RP_id, then it can add the RP_id into the registration request; or if the UA 102 has not known the RP_id, then it can send the registration request to the RP 108 and then the RP 108 can add the RP_id into the registration request and forward it to the apparatus 200.

In another embodiment, the registration request may only contain a signal for indicating a registration request when for example there is only one RP_id in the system. In another embodiment, the registration request can contain a personal registration command (PRC) raised by the user with the UA 102. For example, the UA 102 can include a voice user interface (UI) which can receive the user's voice and pre-process it (e.g., separating noise, extracting characteristic values).

After receiving the registration request, the apparatus 200 may recognize the registration request by for example recognizing the PRC or other suitable method, and generate a unique identifier UA_id that links to the service ID, RP_id if duplication check is positive. For example, the duplication check can be based on the PRC, the UA_add, any suitable information or their combination. In an embodiment, the UA_id may link to the RP_id and the UA_add.

After generating the UA_id, the apparatus 200 can use or generate a series of pattern codes and a sending element 204 of the apparatus 200 may send them to the UA 102. The pattern codes can be provided to the user in any suitable form, such as voice, text, image or video. In an embodiment, the pattern codes can include letters, words, numbers, symbols, sentences or other suitable codes. In an embodiment, the pattern codes may comprise a login pattern code, a registration update pattern code, a registration deletion pattern code or other suitable pattern codes. The UA 102 may provide the user's encrypted bio-patterns which are associated with the pattern codes. For example, the bio-patterns may be personal voice patterns or handwriting patterns corresponding to the patterns codes. The user can repeat the pattern codes using voice or handwriting. The user's bio-patterns may be encrypted with the homomorphic public key PK_TTP of the TTP 104 and sent them to the apparatus 200 by the UA 102. The UA 102 may extract the user's bio-patterns from the bio-information associated with the pattern codes provided by the user and then encrypt them with the homomorphic public key PK_TTP.

Subsequently, the receiving element 202 can receive the encrypted bio-patterns from the UA 102. If the apparatus 200 cannot get sufficient the encrypted bio-patterns, then the sending element 204 can send other pattern codes to the UA 102 again. When the apparatus 200 gets sufficient the encrypted bio-patterns, a storing element 206 can store the encrypted bio-patterns such as in the user's profile. The user's profile can include the user's identifier and the encrypted bio-patterns. In addition, the user profile can also contain any other suitable information. For example, the user profile can contain the UA 102's address and the RP 108's service ID.

Moreover, the sending element 204 can send the registration result to the UA 102 and the RP 108 separately, or send it to the RP 108 and then the RP 108 may forward it to the UA 102. The registration result can indicate whether the registration is successful. If successful, the registration result can contain for example the user's identifier. In another embodiment, the registration result can further contain the UA_add and RP_id or other suitable information. If failure, the registration result may indicate the reason.

When the user has successfully registered, the user can send some authentication request to access some service. With reference to FIG. 3 and FIG. 1, the receiving element 302 of the apparatus 300 may receive an authentication request from the UA 102. The authentication request may include a login request, a registration update request or a registration deletion request or any other suitable request. The authentication request can contain an indication for indicating the type of authentication request. Moreover, the authentication request can also be registered as the encrypted bio-patterns as described above, for example using voice. In this case, the authentication request may include second encrypted bio-information of the user which may be encrypted with the homomorphic public key of the TTP 102. In addition, the authentication request may contain other suitable information, for example, the UA 102's ID, UA 102's address, the service ID, etc. With the login request as an example, the login request may contain the UA_id and the user's voice corresponding to the login pattern codes. Thus, the apparatus 300 can located the user's profile with the UA_id and recognize the authentication request by using any suitable biometric identification technology, such as voice recognition technology.

In an embodiment, the authentication request may include the second encrypted bio-information of the user, and a recognizing element (not shown) of the apparatus 300 may recognize the authentication request based on the second encrypted bio-information. For example the recognizing element can recognize the authentication request by the applying searchable encryption technologies and/or full homomorphic encryption technologies. As an example, if the authentication request is the login request, then the UA 102 may send the second encrypted bio-information corresponding to the login pattern codes (ELPC) (such as encrypted voice characteristic values) to the apparatus 300 with the package (ELPC, UA_id, UA_add, RP_id). Then the receiving element 302 can receive the package and the apparatus 300 can locate corresponding user profile indexed by UA_id through the UA_id. The recognizing element can recognize the ELPC by using searchable encryption technology and/or full homomorphic encryption technology or other suitable method based on the second encrypted bio-information.

After recognizing the authentication request, the apparatus 300 can generate a combination of pattern codes as a verification code, wherein the verification code comprises a combination of pattern codes and the pattern codes are associated with encrypted bio-patterns that the user has registered respectively. For example, if the quantity of the pattern codes is number n, then there may be n+n²+n³+ . . . +nⁿ combinations of the verification codes.

Then a sending element 304 of apparatus 300 can send a verification code to the UA 102. For example, the sending element 304 can send a randomly generated verification code. In this case, even if an attacker nearby could steal voice-input-verification-code, but there may be no way for the attacker to use recorded user verification code input to pass authentication since every time the proposed verification code is different and randomly generated by the apparatus 300 according to context and security requirements. Moreover, the sending element 304 can send multiple verification codes depending on security requirements.

In an embodiment, the sending element 304 can send an indication that first encrypted bio-information corresponding to the verification code should be provided within a specified time.

After the UA 102 has sent the first encrypted bio-information of the user corresponding to the verification code, the receiving element 302 can receive the first encrypted bio-information. According to various embodiments, the encrypted bio-information is encrypted with the homomorphic public key of the TTP 102 by the UA 102.

Then a calculating element 306 of the apparatus 300 can calculate a first encrypted deviation between the registered encrypted bio-patterns corresponding to the combination of pattern codes and the first encrypted bio-information. In an embodiment, the calculation may be performed by applying full homomorphic encryption. Note that the calculation is in an encrypted form. The encrypted deviation cannot be decrypted by the apparatus 300 and can only be decrypted with TTP 104's private key SK_TTP. The calculating element 306 can perform match calculation between the registered encrypted bio-patterns corresponding to the combination of pattern codes and the first encrypted bio-information. In an embodiment, the match can be based on minimum mean squared error (MMSE) or maximum correlation coefficient or the algorithm proposed by Guang Hua; Goh, J.; Thing, V. L. L., A Dynamic Matching Algorithm for Audio Timestamp Identification Using the ENF Criterion, IEEE Trans. on Information Forensics and Security, vol. 9, no. 1, pp. 1045-1055, 2014, which is incorporated herein by reference.

According to various embodiments, the sending element 304, the receiving element 302 and the calculating element 306 can repeatedly perform respective actions with a different combination of pattern codes. For example, the apparatus 300 may send a plurality of verification codes to the UA 102, when the authentication is failure or the authentication criteria is strict, or in response to the RP 108's request. This procedure could be iterated for a predefined maximum times in order to make a correct authentication decision.

Then the sending element 304 can send the encrypted-deviation to the relying party 108. In this embodiment, the sending element 310 can send the encrypted-deviation to the RP 108 to allow it to conclude authentication result.

The receiving element 302 can further receive the authentication result. For example, when the authentication request needs the apparatus 300 to perform some actions, then the receiving element 302 can receive the authentication result.

A performing element (not shown) can perform one or more operations based on the authentication result. For example, supposing that the authentication request is a registration update request, the performing element may perform update operation when the authentication is successful, otherwise may indicate the sending element 302 to send a different verification code to authenticate again or refuse the update operation. The procedure of the registration update request can be similar to the procedure of the register request as described above. Supposing that the authentication request is a registration deletion request, the performing element may perform deletion operation when the authentication is successful, otherwise may indicate the sending element 302 to send a different verification code to authenticate again or refuse the deletion operation.

According to various embodiments, the encrypted bio-patterns may comprise first encrypted context information of the user and/or the first encrypted bio-information comprises second encrypted context information of the user, and the calculating element 306 is further configured to calculate a second encrypted deviation between the context information.

In one embodiment, the calculating element 306 can calculate the second encrypted deviation between the context information of multiple encrypted bio-patterns. This second encrypted deviation can allow a party (for example, the RP 108) to check whether the contexts of the multiple encrypted bio-patterns are the same or similar.

In another embodiment, the calculating element 306 can calculate the second encrypted deviation between the context information of multiple first encrypted bio-information. This second encrypted deviation can allow a party (for example, the RP 108) to check whether the contexts of the multiple first encrypted bio-information are the same or similar.

In still another embodiment, the calculating element 306 can calculate the second encrypted deviation between the first encrypted context information and the second encrypted context information. This second encrypted deviation can allow a party (for example, the RP 108) to check whether the first encrypted context information and the second encrypted context information are the same or similar.

Moreover, the context information can include the background noise, surrounding temperature, login time, login device, etc. This context information can be encrypted and computed like the bio-information to allow for example the RP 108 to check the context information similarity. For example, background noise characteristic values may be encrypted, and compared with previous values if any in an encrypted form. This comparison result (such as the encrypted context information deviation) can also be sent to the RP 108 in order to fight against some potential attacks on the invention.

According to various embodiments, the bio-information is obtained from the user's voice or handwriting. For example, the user can input his voice with a microphone or input the handwriting with a touch panel/screen.

According to various embodiments, the encryption as described herein may be performed through homomorphic encryption. For example, the UA 102 can encrypt the user's bio-information or other suitable information (such as the background noise) with the TTP 104's homomorphic public key. Moreover, the IdP 106 can calculate the encrypted deviation with full homomorphic encryption technology, and the TTP 104 can generate a re-encryption key for the RP 108 so that the RP 108 can re-encrypt the encrypted deviation and decrypt it with its private key.

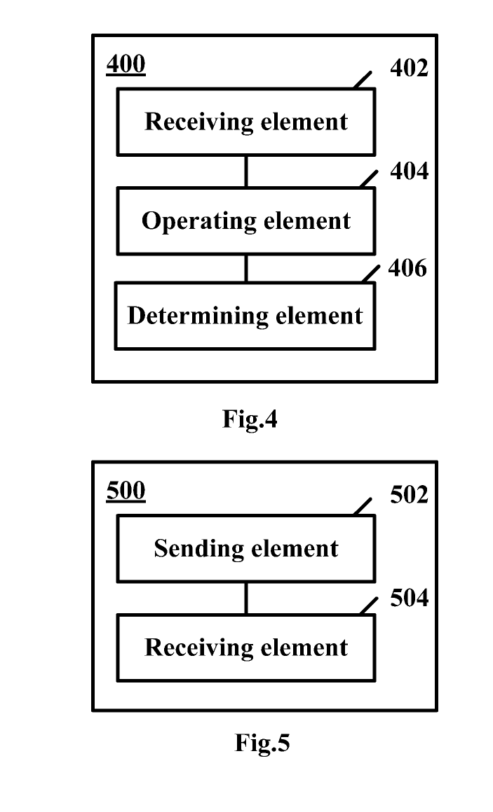

FIG. 4 shows a simplified block diagram of an apparatus 400 for authentication in a system according to an embodiment of the present disclosure. As described above, the system may comprise the components as described in FIG. 1. The apparatus 400 can be implemented as a part of the RP 108 in FIG. 1.

With reference to FIG. 4 and FIG. 1, the apparatus 400 may include a receiving element 402 configured to receive an encrypted-deviation from the IdP 106, wherein the encrypted-deviation may be calculated by the apparatus 300 as described above. In an embodiment, the encrypted-deviation may comprise an encrypted-deviation of bio-information and/or an encrypted-deviation of context information as described above.

Then an operating element 404 of the apparatus 400 can operate on the encrypted-deviation. Since the encrypted-deviation may be encrypted with the homomorphic public key of the TTP 104, the operating element 404 cannot directly decrypt the encrypted-deviation due to without the homomorphic private key. In an embodiment, the operating element 404 can receive a re-encryption key from the TTP 104. The re-encryption key can be generated by using any suitable method. Then the operating element 404 can re-encrypt the encrypted-deviation with the re-encryption key; and decrypt the re-encrypted encrypted-deviation with its private key. In another embodiment, the operating element 404 can send the encrypted-deviation to the TTP 104 to require the TTP 104 to decrypt the encrypted-deviation and send back the decryption result. In this case, the operating element 404 can receive the decryption result from the TTP 104.

After the operating element 404 has decrypted the encrypted-deviation, a determining element 406 of the apparatus 400 can determine authentication result based on the operation (such as decryption) result. The decryption result contains the decrypted deviation. In an embodiment, a successful authentication can be defined that each pattern code's match percent should be over a predefined threshold, the average match percent should be over another predefined threshold, the deviation should be below an expected threshold, or their combination, or other suitable criteria. In another embodiment, the decryption result may comprise the deviation of context information, such as the background noise, and the determining element 406 may check the deviation of context information. For example, information similarity of the context information of the user, such as background noise, is applied to double check that the repeated verification code and its registered pattern codes are provided in the same context or each challenged pattern code is provided in the same context or each repeated verification code is provided in the same context in order to fight against some potential attacks on the invention. The authentication result can indicate whether the authentication is successful, and contain any other suitable information.

Then a sending element (not shown) of the apparatus 400 can send the authentication result to an appropriate entity or use it by itself depending on the authentication request. As an example, the sending element can send the authentication result to the UA 102 and/or the IdP 106 and/or other suitable entities. When the RP 108, the UA 102 and/or the IdP 106 and/or other suitable entities have got the authentication result, they can perform their respective actions based on the authentication result.

For example, when the authentication request is a login request, the sending element can send the authentication result to the UA 102. If the authentication is successful, the apparatus 400 can permit the UA 102 to access its service, otherwise it will reject service access from the UA 102.

When the authentication request is a registration update request, the sending element can send the authentication result to the IdP 106. The IdP 106 may perform update operations when the authentication is successful, otherwise may send a different verification code to authenticate again or refuse the update operation.

When the authentication request is a registration deletion request, the sending element can send the authentication result to the IdP 106. The IdP 106 may perform deletion operation when the authentication is successful, otherwise may send a different verification code to authenticate again or refuse the deletion operation.

According to various embodiments, the deviation is encrypted through homomorphic encryption. For example, as described above, the IdP 106 can compute the encrypted-deviation by using full homomorphic encryption.

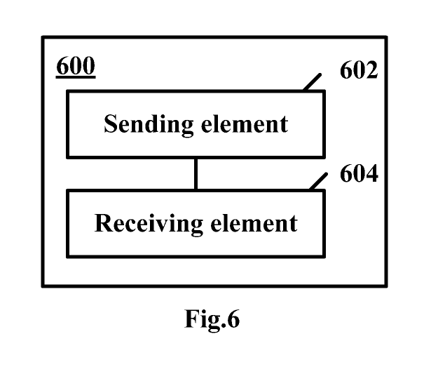

FIGS. 5 and 6 separately show simplified block diagrams of an apparatus 500 and an apparatus 600 for authentication in a system according to various embodiments of the present disclosure. As described above, the system may comprise the components as described in FIG. 1. The apparatus 500, 600 can be implemented as a part of the UA 102 in FIG. 1. Noted that the apparatus 500, 600 may perform operations that are complementary to the operations of the apparatus 200, 300 separately. Thus, some description already mentioned above is omitted here for brevity.

With reference to FIG. 5 and FIG. 1, the apparatus 500 may include a sending element 502 configured to send a registration request to the IdP 106. As described above, the sending element 502 can directly send the registration request to the IdP 106, or send the registration request to the RP 108 and then the RP 108 can forward the registration request to the IdP 106.

As described above, when the IdP 106 has received the registration request, it will use or generate a series of pattern codes and send the pattern codes to the UA 102. Then a receiving element 504 of the apparatus 500 can receive the pattern codes.

In this embodiment, the user of the UA 102 can provide the user's bio-information corresponding to the pattern codes, and the UA 102 can process it to generate the bio-patterns, and encrypt the bio-patterns with the homomorphic public key PK_TTP of the TTP 104. Then a sending element 506 can send the encrypted bio-patterns to the IdP 106. As described above, the pattern codes may comprise a login pattern code, a registration update pattern code, a registration deletion pattern code or other suitable pattern codes. In other words, the user can also register his/her encrypted specified pattern codes. For example, when the pattern codes include the login pattern codes, the user can utter the login pattern code and register them in the IdP 106.

As described above, the IdP 106 can send the registration result. The receiving element 504 can receive the registration result. The registration result can indicate whether the registration is successful. If successful, the registration result can contain the unique identifier. In another embodiment, the registration result can further contain the UA_add and RP_id. If failure, the registration result may indicate the reason.

When the user has successfully registered, the user can send some authentication request to access some service. With reference to FIG. 6 and FIG. 1, the apparatus 600 may comprise a sending element 602 configured to send an authentication request to the IdP 106. The authentication request may include a login request, a registration update request or a registration deletion request or any other suitable request as described above.

According to an embodiment, the authentication request may include the second encrypted bio-information of the user, and the IdP 106 may recognize the authentication request based on the second encrypted bio-information as described above.

Then a receiving element 604 of the apparatus 600 can receive a verification code from the IdP 106, wherein the verification code comprises a combination of pattern codes and the pattern codes are associated with encrypted bio-patterns that the user has registered respectively. The user of apparatus 600 can provide corresponding bio-information based on the verification code. For example, if the verification code indicates the user to raise “number 0 to 9” one by one, then the user can utter “number 0 to 9” one by one with a microphone of the apparatus 600. If the verification code indicates the user to write a word “authentication”, then the user can write the word with a touch screen or handwriting pad of the apparatus 600.

In an embodiment, the receiving element 604 can receive an indication that encrypted bio-information corresponding to the verification code should be provided within a specified time. Then the user may know it and provide the bio-information within the specified time.

The apparatus 600 can encrypt the user's bio-information corresponding to the verification code with the homomorphic public key of the TTP 102, and the sending element 602 may send the first encrypted bio-information of the user corresponding to the verification code to the IdP 106. In an embodiment, before encrypting, the apparatus 600 can pre-process the user's bio-information for example in order to extract its characteristic values.

According to various embodiments, the receiving element 604 and the sending element 602 can repeatedly perform respective actions with a different combination of pattern codes. This procedure could be iterated for maximum times in order to make a correct authentication decision.

In an embodiment, the apparatus 600 can further receive the authentication result. For example, supposing that the authentication request is a login request, the apparatus 600 may access the service provided by the RP 108 when the authentication is successful, otherwise the apparatus 600 may send another authentication request.

According to various embodiments, the encrypted bio-patterns may comprise first encrypted context information of the user and/or the first encrypted bio-information comprises second encrypted context information of the user. For example, the context information can include the background noise, surrounding temperature, login time, login device, etc. This context information can be encrypted and computed like the bio-information to allow for example the RP 108 to check the context information similarity.

According to various embodiments, the bio-information may be obtained from the user's voice or handwriting. For example, the user can input the voice with a microphone or input the handwriting with a touch panel/screen. According to various embodiments, the encryption as described herein may be performed through homomorphic encryption.

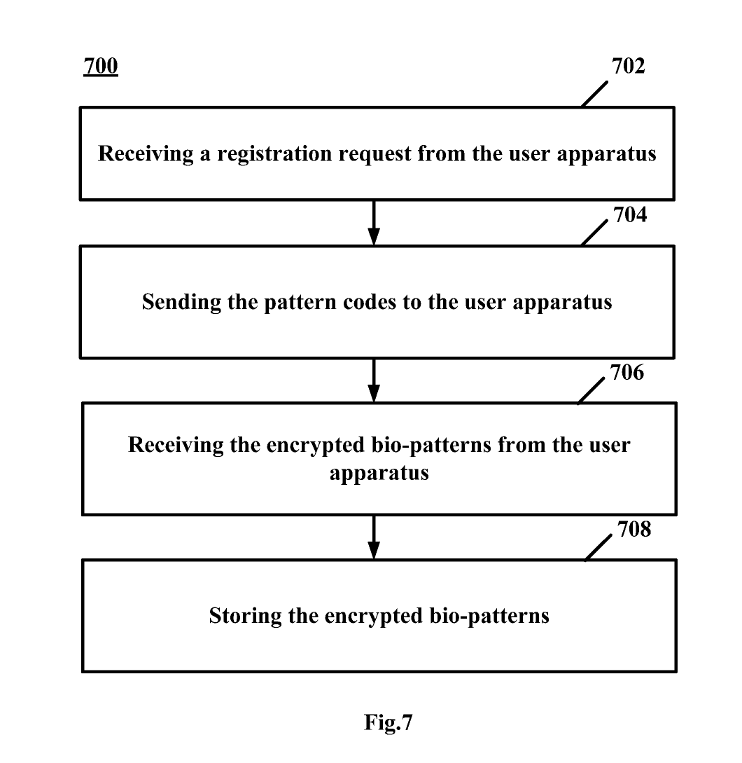

Under the same inventive concept, FIGS. 7 to 12 are flow charts showing processes for authentication according to some embodiments of the present disclosure. The present disclosure will be described below with reference to these figures. For same parts or functions as described in the previous embodiments, the description thereof is omitted for brevity.

FIG. 7 shows a process 700 for authentication in a system according to an embodiment of the present disclosure. As described above, the system may comprise the components as described in FIG. 1. The process 700 can be performed by the apparatus 200 shown in FIG. 2.

As shown in FIG. 7, the process 700 may begin with a step 702. At 702, the apparatus 200 may receive a registration request from the UA 102. The registration request can contain any suitable information as described above. After receiving the registration request, the apparatus 200 may recognize the registration request by for example recognizing a personal registration command raised by the user or other suitable method. The apparatus 200 may generate a unique identifier UA id for the user of UA 102 that links to a service if duplication check is positive.

At 704, the apparatus 200 can use or generate a series of pattern codes and send them to the UA 102. In an embodiment, the pattern codes may comprise a login pattern code, a registration update pattern code, a registration deletion pattern code or other suitable pattern codes. At 706, the apparatus 200 may receive the encrypted bio-patterns from the UA 102 which are associated with the pattern codes. When the apparatus 200 gets sufficient the encrypted bio-patterns, it can store the encrypted bio-patterns such as in the user's profile at 708. Moreover, the apparatus 200 can send the registration result to the UA 102 and/or the RP 108. If the apparatus 200 cannot get sufficient the encrypted bio-patterns, then the process 700 may get back to step 704.

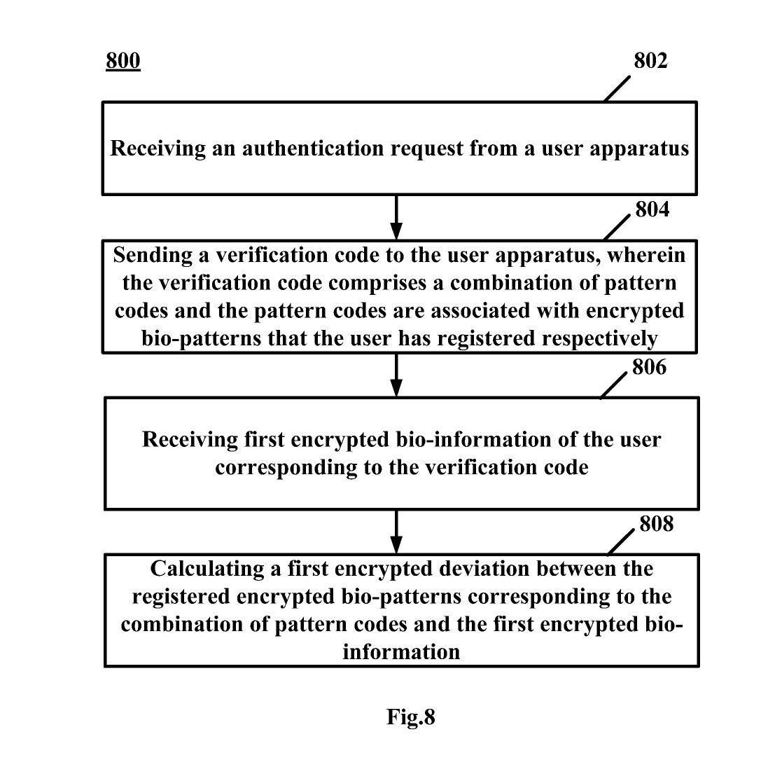

FIG. 8 shows a process 800 for authentication in a system according to an embodiment of the present disclosure. As described above, the system may comprise the components as described in FIG. 1. The process 800 can be performed by the apparatus 300 shown in FIG. 3.

At step 802, the apparatus 300 may receive an authentication request from the UA 102. The authentication request may include a login request, a registration update request or a registration deletion request or any other suitable request. In an embodiment, the authentication request may include second encrypted bio-information of the user which may be encrypted with the homomorphic public key of the TTP 102. In addition, the authentication request may contain other suitable information as described above.

According to an embodiment, the authentication request may include the second encrypted bio-information of the user, and the process 800 can include a recognizing step configured to recognize the authentication request based on the second encrypted bio-information.

After recognizing the authentication request, the apparatus 300 can generate a combination of pattern codes as a verification code, wherein the verification code comprises a combination of pattern codes and the pattern codes are associated with encrypted bio-patterns that the user has registered respectively.

Then at 804, the apparatus 300 can send the verification code to the UA 102. In an embodiment, the apparatus 300 can send an indication that first encrypted bio-information corresponding to the verification code should be provided within a specified time.

Then at 806, the apparatus 300 may receive the first encrypted bio-information of the user corresponding to the verification code. According to various embodiments, the encrypted bio-information may be encrypted with the homomorphic public key of the TTP 102 by the UA 102.

After receiving the first encrypted bio-information, at 808, the apparatus 300 may calculate an encrypted deviation between the registered encrypted bio-patterns corresponding to the combination of pattern codes and the first encrypted bio-information. In an embodiment, the calculation may be performed by applying full homomorphic encryption.

According to various embodiments, the steps 804, 806, 808 can be repeatedly performed with a different combination of pattern codes. This procedure could be iterated for predefined maximum times in order to make a correct authentication decision.

The process 800 can include a sending step configured to send the encrypted-deviation to the RP 108. In this embodiment, the sending step can send the encrypted-deviation to the RP 108 to allow it to conclude authentication result.

The process 800 can include a receiving step configured to receive the authentication result. For example, when the authentication request needs the apparatus 300 to perform some actions, then the receiving step can receive the authentication result.

The process 800 can include a performing step configured to perform one or more operations based on the authentication result as described above.

According to various embodiments, the encrypted bio-patterns comprises first encrypted context information of the user and/or the first encrypted bio-information comprises second encrypted context information of the user, and at 808, the apparatus 300 may calculate a second encrypted deviation between the encrypted context information. For example, the context information can include the background noise, surrounding temperature, login time, login device, etc. As described above, at 808, the apparatus 300 may calculate the second encrypted deviation between the context information of multiple encrypted bio-patterns, or between the context information of multiple first encrypted bio-information, or between the first encrypted context information and the second encrypted context information. This context information can also be encrypted and computed like the bio-information to allow for example the RP 108 to check the context information similarity in order to fight against some potential attacks on the invention. This comparison result (such as the encrypted context information deviation) can also be sent to the RP 108.

According to various embodiments, the bio-information is obtained from the user's voice or handwriting. According to various embodiments, the encryption as described herein may be performed through homomorphic encryption.

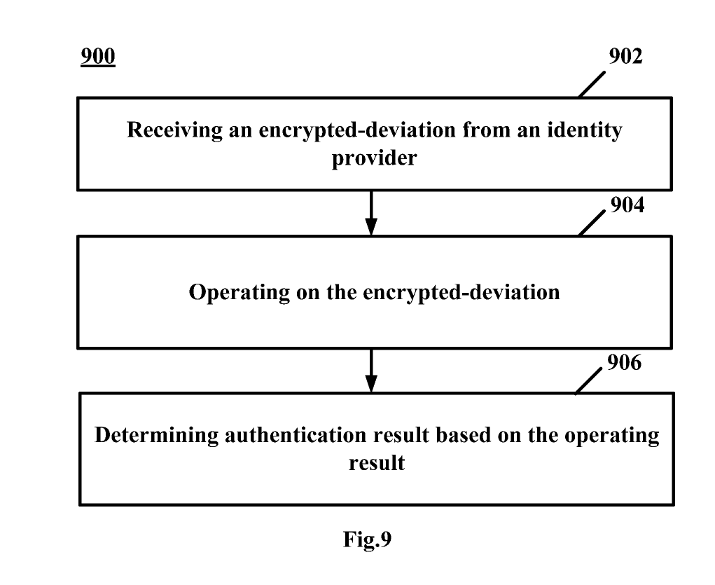

FIG. 9 shows a process 900 for authentication in a system according to an embodiment of the present disclosure. As described above, the system may comprise the components as described in FIG. 1. The process 900 can be performed by the apparatus 400 shown in FIG. 4.

As shown in FIG. 9, at 902, the apparatus 400 may receive an encrypted-deviation from the IdP 108, wherein the encrypted-deviation may be calculated by the apparatus 300 as described above. In an embodiment, the encrypted-deviation comprises an encrypted-deviation of bio-information and/or an encrypted-deviation of context information.

At 904, the apparatus 400 can operate on the encrypted-deviation. In an embodiment, at 904, the apparatus 400 can re-encrypt the encrypted-deviation with a re-encryption key received from a trusted third party; and decrypt the re-encrypted encrypted-deviation with its private key. In another embodiment, at 904, the apparatus 400 can send the encrypted-deviation to the TTP 104 to require the TTP 104 to decrypt the encrypted-deviation and send back the decryption result. In this case, the apparatus 400 can receive the decryption result from the TTP 104.

After decrypting the encrypted-deviation, at 906, the apparatus 400 can determine authentication result based on the operation (decryption) result. The decryption result contains the decrypted deviation. In an embodiment, a successful authentication can be defined that each pattern code's match percent should be over a predefined threshold, the average match percent should be over another predefined threshold, the deviation should be below an expected threshold, or their combination, or other suitable criteria. In another embodiment, the decryption result may comprise the deviation of context information, such as the background noise, and the apparatus 400 may check the context information similarity as described above. The authentication result can indicate whether the authentication is successful, and contain any other suitable information.

The process 900 can include a sending step configured to send the authentication result. For example, the sending step can send the authentication result to an appropriate entity depending on the authentication request as described above.

According to various embodiments, the deviation is encrypted through homomorphic encryption. For example, as described above, the IdP 106 can compute the encrypted-deviation by using full homomorphic encryption.

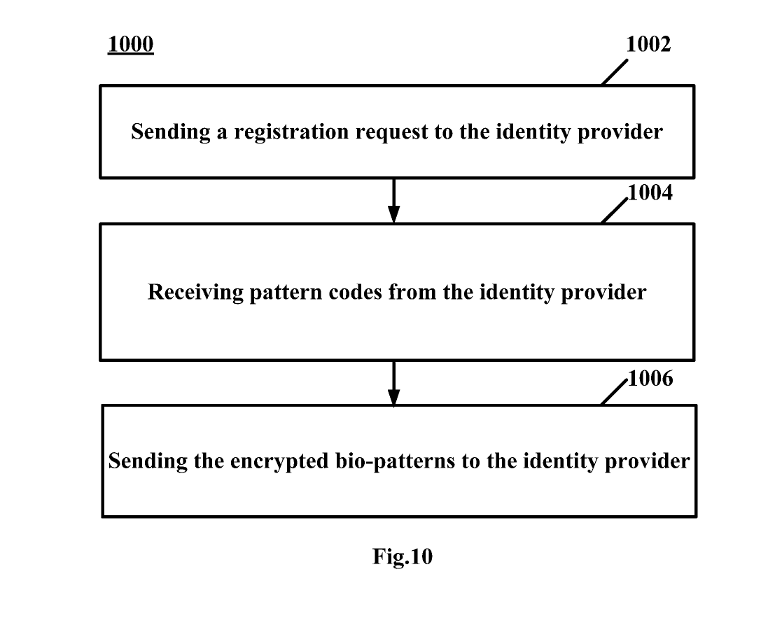

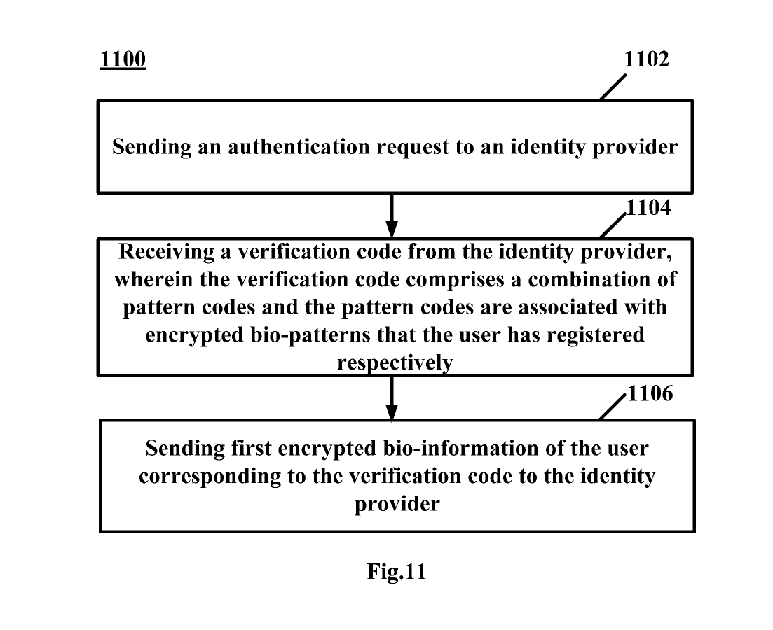

FIG. 10-11 shows processes 1000, 1100 for authentication in a system according to some embodiments of the present disclosure. As described above, the system may comprise the components as described in FIG. 1. The processes 1000, 1100 can be performed by the apparatus 500, 600 shown in FIG. 5, 6 separately. Noted that the processes 1000, 1100 are complementary to the processes 700, 800 separately.

As shown in FIG. 10, at 1002, the apparatus 500 may send a registration request to the IdP 106. At 1004, the apparatus 500 may receive the pattern codes. In this embodiment, the user of the apparatus 500 can provide the user's bio-information corresponding to the pattern codes, and the apparatus 500 can process it to generate the bio-patterns, and encrypt the bio-patterns with the homomorphic public key PK_TTP of the TTP 104.

At 1006, the apparatus 500 can send the encrypted bio-patterns to the IdP 106. As described above, the pattern codes may comprise a login pattern code, a registration update pattern code, a registration deletion pattern code or other suitable pattern codes.

The processes 1000 can include a receiving step configured to receive the registration result. The registration result can indicate whether the registration is successful.

As shown in FIG. 11, at 1102, the apparatus 600 may send an authentication request to the IdP 106. The authentication request may include a login request, a registration update request or a registration deletion request or any other suitable authentication request as described above. According to an embodiment, the authentication request may include the second encrypted bio-information of the user.

At 1104, the apparatus 600 can receive a verification code from the IdP 106, wherein the verification code comprises a combination of pattern codes and the pattern codes are associated with encrypted bio-patterns that the user has registered respectively. In an embodiment, at 1104, the apparatus 600 can receive an indication that encrypted bio-information corresponding to the verification code should be provided within a specified time. Then the user may know it and provide the bio-information within the specified time.

Then the apparatus 600 can encrypt the user's bio-information corresponding to the verification code with the homomorphic public key of the TTP 102, and at 1106, send the first encrypted bio-information of the user corresponding to the verification code to the IdP 106. In an embodiment, before encrypting, the apparatus 600 can pre-process the user's bio-information for example in order to extract its characteristic values.

According to various embodiments, the steps 1104, 1106 can be repeatedly performed with a different combination of pattern codes. This procedure could be iterated for maximum times in order to make a correct authentication decision.

In an embodiment, the process 1100 can include a receiving step configured to receive the authentication result as described above.

According to various embodiments, the encrypted bio-patterns comprises first encrypted context information of the user and/or the first encrypted bio-information may comprise second encrypted context information of the user. For example, the context information can include the background noise, surrounding temperature, login time, login device, etc. This context information can also be encrypted and computed like the bio-information to allow for example the RP 108 to check the context information similarity in order to fight against some potential attacks on the invention.

According to various embodiments, the bio-information is obtained from the user's voice or handwriting. For example, the user can input his/her voice with a microphone or input the handwriting with a touch panel/screen. According to various embodiments, the encryption as described herein may be performed through homomorphic encryption.

It is noted that any of the components of the apparatus 200, 300, 400, 500, 600 depicted in FIG. 2-6 can be implemented as hardware or software modules. In the case of software modules, they can be embodied on a tangible computer-readable recordable storage medium. All of the software modules (or any subset thereof) can be on the same medium, or each can be on a different medium, for example. The software modules can run, for example, on a hardware processor. The method steps can then be carried out using the distinct software modules, as described above, executing on a hardware processor.

According to an aspect of the disclosure it is provided an apparatus for authentication. Said apparatus comprises means configured to receive an authentication request from a user apparatus; means configured to send a verification code to the user apparatus, wherein the verification code comprises a combination of pattern codes and the pattern codes are associated with encrypted bio-patterns that the user has registered respectively; means configured to receive first encrypted bio-information of the user corresponding to the verification code; and means configured to calculate a first encrypted deviation between the registered encrypted bio-patterns corresponding to the combination of pattern codes and the first encrypted bio-information.

According to an embodiment, the apparatus further comprises means configured to send the encrypted deviation to a relying party. According to an embodiment, the apparatus further comprises means configured to receive a registration request from the user apparatus; means configured to send the pattern codes to the user apparatus; means configured to receive the encrypted bio-patterns from the user apparatus; and means configured to store the encrypted bio-patterns.

According to an embodiment, the authentication request comprises a login request, a registration update request or a registration deletion request.

According to an embodiment, wherein the authentication request includes second encrypted bio-information of the user and the apparatus further comprises means configured to recognize the authentication request based on the second encrypted bio-information.

According to an embodiment, the apparatus further comprises means configured to receive the authentication result from the relying party; and means configured to perform one or more operations based on the authentication result.

According to an embodiment, wherein the encrypted bio-patterns comprises first encrypted context information of the user and/or the first encrypted bio-information comprises second encrypted context information of the user, and the calculating means is further configured to calculate a second encrypted deviation between the encrypted context information.

According to an embodiment, wherein the bio-information is obtained from the user's voice or handwriting.

According to an embodiment, wherein the encryption is performed through homomorphic encryption.

According to another aspect of the disclosure it is provided an apparatus for authentication. Said apparatus comprises means configured to receive an encrypted-deviation from an identity provider; means configured to operate on the encrypted-deviation; and means configured to determine authentication result based on the operation result.

According to an embodiment, said operating means further comprises means configured to re-encrypt the encrypted-deviation with a re-encryption key received from a trusted third party; and means configured to decrypt the re-encrypted encrypted-deviation with the apparatus's private key.

According to an embodiment, said operating means further comprises means configured to send the encrypted-deviation to a trusted third party; and means configured to receive a decryption result from the trusted third party.

According to an embodiment, wherein the encrypted-deviation comprises an encrypted-deviation of bio-information and/or an encrypted-deviation of context information.

According to an embodiment, said apparatus further comprises means configured to send the authentication result to the identity provider.

According to an embodiment, wherein the deviation is encrypted through homomorphic encryption.

According to another aspect of the disclosure it is provided an apparatus for authentication. Said apparatus comprises means configured to sending an authentication request to an identity provider; means configured to receive a verification code from the identity provider, wherein the verification code comprises a combination of pattern codes and the pattern codes are associated with encrypted bio-patterns that the user has registered respectively; and means configured to send first encrypted bio-information of the user corresponding to the verification code to the identity provider.

According to an embodiment, said apparatus further comprises means configured to send a registration request to the identity provider; means configured to receive pattern codes from the identity provider; and means configured to send the encrypted bio-patterns to the identity provider.

According to an embodiment, wherein the authentication request comprises a login request, a registration update request or a registration deletion request.

According to an embodiment, wherein the authentication request includes second encrypted bio-information of the user.

According to an embodiment, wherein the encrypted bio-patterns comprises first encrypted context information of the user and/or the first encrypted bio-information comprises second encrypted context information of the user.

According to an embodiment, wherein the bio-information is obtained from the user's voice or handwriting.

According to an embodiment, wherein the encryption is performed through homomorphic encryption.

Additionally, an aspect of the disclosure can make use of software running on a computing device. Such an implementation might employ, for example, a processor, a memory, and an input/output interface formed, for example, by a display and a keyboard. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. The processor, memory, and input/output interface such as display and keyboard can be interconnected, for example, via bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with media.

Accordingly, computer software including instructions or code for performing the methodologies of the disclosure, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

As noted, aspects of the disclosure may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the disclosure may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

The authentication solution described in the present disclosure has the following advantages:

Usability: the disclosure provides a usable authentication solution. No need for the user to remember user IDs and passwords. It is suitable for different user groups, e.g., children and elders. Bio-information authentication is applied based on auto-challenge.
Flexibility: the authentication solution can be used for either online service authentication or user device authentication. It can be used for many services at the same time. The system structure of the authentication solution supports deploying it for different services that needs user authentication. It easily realizes federated identity management. Due to the unique of individual bio-information, various services can share the same IdP for user authentication. This makes it easy to deploy the IdP as a cloud service.
Security: the security of the authentication solution is ensured in the following way: 1) authentication accuracy is based on bio-information recognition and match with personal bio-information patterns; 2) authentication security is enhanced by using different verification codes (randomly generated) to challenge the user. The verification code is different in each time, thus there is no way for an attacker to use recorded user verification code input to pass authentication; 3) the verification code challenge should be fulfilled within limited time. If the user cannot repeat the verification code in the limited time, the authentication will fail; 4) similarity of context information such as background voice is applied to double check that all repeated verification codes, all input verification pattern codes during one challenge and/or corresponding registered pattern code are provided in the same context.
Privacy preservation: the bio-information of an individual user is not disclosed to either the RP or the IdP. The personal bio-information characteristic values and bio-information patterns are encrypted by PK TTP, thus RP and IdP cannot get the plaintext of bio-information characteristic values. For authentication verification, only encrypted comparison results are provided to the RP that can decrypt it through re-encryption and decryption in order to conclude authentication. In this way, user private bio-information is protected from service providers that need to authenticate users for service access and identity management providers that saves identification information and processes authentication.

The flowchart and block diagrams in the figures illustrate the architecture, functionality, and operation of possible implementations of systems, methods and computer program products according to various embodiments of the disclosure. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In any case, it should be understood that the components illustrated in this disclosure may be implemented in various forms of hardware, software, or combinations thereof, for example, application specific integrated circuit(s) (ASICS), functional circuitry, an appropriately programmed general purpose digital computer with associated memory, and the like. Given the teachings of the disclosure provided herein, one of ordinary skill in the related art will be able to contemplate other implementations of the components of the disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. It will be further understood that the terms “comprises”, “containing” and/or “comprising,” when used in this specification, specify the presence of stated features, integers, steps, operations, elements, and/or components, but do not preclude the presence or addition of another feature, integer, step, operation, element, component, and/or group thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1-55. (canceled)

56. A method for authentication comprising:
receiving an authentication request from a user apparatus;
sending a verification code to the user apparatus, wherein the verification code comprises a combination of pattern codes and the pattern codes are associated with encrypted bio-patterns that the user has registered respectively;
receiving first encrypted bio-information of the user corresponding to the verification code; and
calculating a first encrypted deviation between the registered encrypted bio-patterns corresponding to the combination of pattern codes and the first encrypted bio-information.

57. The method according to claim 56, further comprising:
repeating the steps of sending, receiving and calculating with a different combination of pattern codes.

58. The method according to claim 56, further comprising:
sending the encrypted deviation to a relying party.

59. The method according to claim 56, further comprising: before the step of receiving the authentication request,
receiving a registration request from the user apparatus;
sending the pattern codes to the user apparatus;
receiving the encrypted bio-patterns from the user apparatus; and
storing the encrypted bio-patterns.

60. The method according to claim 56, wherein the authentication request includes second encrypted bio-information of the user and the method further comprises recognizing the authentication request based on the second encrypted bio-information.

61. The method according to claim 58, further comprising:
receiving the authentication result from the relying party; and
performing one or more operations based on the authentication result.

62. The method according to claim 56, wherein the encrypted bio-patterns comprises first encrypted context information of the user and/or the first encrypted bio-information comprises second encrypted context information of the user, and the step of calculating further comprises calculating a second encrypted deviation between the encrypted context information.

63. An apparatus comprising
at least one processor; and
at least one memory including computer program code;
the at least one memory and the computer program code configured to, with the at least one processor, cause the apparatus at least to:
receive an encrypted-deviation from an identity provider;
operate on the encrypted-deviation; and
determine authentication result based on the operation result.

64. The apparatus according to claim 63, further comprise to re-encrypt the encrypted-deviation with a re-encryption key received from a trusted third party; and to decrypt the re-encrypted encrypted-deviation with the apparatus's private key.

65. The apparatus according to claim 63, further comprise to send the encrypted-deviation to a trusted third party; and to receive a decryption result from the trusted third party.

66. The apparatus according to claim 63, wherein the encrypted-deviation comprises an encrypted-deviation of bio-information and/or an encrypted-deviation of context information.

67. The apparatus according to claim 63, further caused to:
send the authentication result to the identity provider.

68. The apparatus according to claim 63, wherein the deviation is encrypted through homomorphic encryption.

69. An apparatus comprising
at least one processor; and
at least one memory including computer program code;
the at least one memory and the computer program code configured to, with the at least one processor, cause the apparatus at least to:
send an authentication request to an identity provider;
receive a verification code from the identity provider, wherein the verification code comprises a combination of pattern codes and the pattern codes are associated with encrypted bio-patterns that the user has registered respectively; and
send first encrypted bio-information of the user corresponding to the verification code to the identity provider.

70. The apparatus according to claim 69, further cause to:
send a registration request to the identity provider;
receive pattern codes from the identity provider; and
send the encrypted bio-patterns to the identity provider.

71. The apparatus according to claim 69, wherein the authentication request comprises a login request, a registration update request or a registration deletion request.

72. The apparatus according to claim 69, wherein the authentication request includes second encrypted bio-information of the user.

73. The apparatus according to claim 69, wherein the encrypted bio-patterns comprises first encrypted context information of the user and/or the first encrypted bio-information comprises second encrypted context information of the user.

74. The apparatus according to claim 69, wherein the bio-information is obtained from the user's voice or handwriting.

75. The apparatus according to claim 69, wherein the encryption is performed through homomorphic encryption.
